(19) United States
(12) Patent Application Publication
(10) Pub. No.: US 2024/0408705 A1
(43) Pub. Date: Dec. 12, 2024

(54) WATER-SOLUBLE FLUX AND SOLDER PASTE

(71) Applicant: SENJU METAL INDUSTRY CO., LTD., Adachi-ku, Tokyo (JP)

(72) Inventors: Yo YAMADA, Tokyo (JP); Tomohiro YAMAGAME, Tokyo (JP)

(21) Appl. No.: 18/703,833

(22) PCT Filed: Oct. 4, 2022
(86) PCT No.: PCT/JP2022/037136

§ 371 Date: Apr. 23, 2024

(30) Foreign Application Priority Data
Nov. 10, 2021 (JP) 2021-183673

(51) Int. Cl. B23K 35/36; B23K 35/02; B23K 35/26; B23K 35/362; C22C 13/00

(52) U.S. Cl. CPC B23K 35/3618; B23K 35/025; B23K 35/262; B23K 35/3613; B23K 35/362; C22C 13/00

(57) ABSTRACT

This water-soluble flux capable of further suppressing the occurrence of voids contains a keto acid having a melting point of 40° C. or lower and a solvent having a boiling point of 240° C. or lower.

### TECHNICAL FIELD

The present invention relates to a water-soluble flux and a solder paste.

Priority is claimed on Japanese Patent Application No. 2021-183673, filed Nov. 10, 2021, the content of which is incorporated herein by reference.

### BACKGROUND ART

Fixing of parts to a substrate and electrical connection of parts to a substrate are generally performed by soldering. A flux, a solder powder, and a solder paste that is a mixture of a flux and a solder powder are used to carry out soldering.

A flux has an efficacy of chemically removing metal oxides that are present on both a metal surface of an object to be soldered and a solder, thereby allowing the movement of metal elements at the boundaries of both. Therefore, soldering using a flux allows intermetallic compounds to be formed therebetween, thereby forming a firm bond.

In a case where soldering is conducted using a solder paste, the solder paste is printed on a substrate, and then a part is mounted thereon, followed by heating the substrate on which the part is mounted in a heating furnace called a reflow furnace. Thus, a solder powder contained in the solder paste is melted to allow the part to be soldered to the substrate.

A flux generally contains a resin component, a solvent, an activator, a thixotropic agent, and the like. Any excess flux after soldering is removed by washing in order to improve the reliability of joining between the solder and the object to be joined. Any flux remaining even after washing is called flux residue.

A rosin, which exhibits excellent electrical insulation, moisture resistance, and the like, has been conventionally used as a resin component in a flux. A flux containing a rosin requires an organic solvent to carry out washing after soldering, which may cause problems in terms of safety, the environment, or the like. Therefore, a water-soluble flux that can be easily washed with water after soldering has been required.

In contrast, Patent Document 1 describes a flux containing an organic acid polyglycerol ester, a thixotropic agent, and a solvent having a specific SP value. The washability with water after soldering is further enhanced by the flux described in Patent Document 1.

### CITATION LIST

### Patent Document

### [Patent Document 1]

Japanese Unexamined Patent Application Publication No. 2016-43398

### SUMMARY OF INVENTION

### Technical Problem

In recent years, miniaturized parts such as QFN (Quad Flat Non-Leaded Package) have been used. Since a QFN does not have leads around a package and has an exposed surface of a lead frame and electrode terminals on the back surface of the package, a solder paste is used to join the back surface of the QFN to the surface of the substrate when the QFN is soldered.

In the case where an exposed surface of a lead frame and electrode terminals on a back surface of a package such as a QFN are soldered to a substrate, a flux residue is likely to remain on the back surface of the package. In addition, the flux residue remaining on the back surface of the package causes the generation of voids. On the other hand, it is difficult to suppress the generation of voids by the solder paste using the flux described in Patent Document 1.

Therefore, the present invention aims to provide a flux and a solder paste that can further suppress the generation of voids.

### Solution to Problem

The present invention adopts the following configuration so as to solve the above-mentioned problems.

Namely, the first aspect of the present invention provides a water-soluble flux containing: a keto acid having a melting point of 40° C. or less; and a solvent having a boiling point of 240° C. or less.

In the water-soluble flux of the first aspect, the boiling point of the keto acid is further preferably 250° C. or less.

In the water-soluble flux according to the first aspect, the amount of the keto acid relative to the total mass (100% by mass) of the water-soluble flux is preferably 10% by mass to 25% by mass.

In the water-soluble flux according to the first aspect, the keto acid preferably includes an organic acid having one carboxy group in a molecule thereof.

In the water-soluble flux according to the first aspect, the keto acid preferably includes a levulinic acid.

In the water-soluble flux according to the first aspect, the ratio of the solvent to the keto acid, which is the mass ratio indicated by solvent/keto acid, is preferably 0.60 to 4.0.

It is preferable that the water-soluble flux according to the first aspect further contain a nonionic surfactant and an amine.

In the water-soluble flux according to the first aspect, it is preferable that at least one resin component selected from the group consisting of rosins and thermosetting resins be absent.

In addition, the second aspect of the present invention provides a solder paste containing a solder alloy powder and the water-soluble flux of the first aspect.

### Advantageous Effects of Invention

The present invention makes it possible to provide a flux and a solder paste that can further suppress the generation of voids.

### BRIEF DESCRIPTION OF DRAWINGS

FIG. 1 is a drawing showing a reflow profile in an evaluation of void area ratio.

### DESCRIPTION OF EMBODIMENTS

### (Water-Soluble Flux)

A water-soluble flux according to the present embodiment contains a keto acid and a solvent.

In the present invention, the term “water-soluble flux” refers to a flux which allows the removal of a flux residue thereof by conducting washing with water. Hereinafter, the water-soluble flux may be simply referred to as flux.

In the present specification, the term “boiling point” means the temperature of a target liquid at which the saturated vapor pressure of the target liquid is equal to 1 atmosphere (namely, 1013 hPa).

In the present specification, the term “melting point” means the temperature at which a solid melts to become a liquid. The values of the melting points of compounds in the present specification are mainly the values described in “Kagaku Binran, Basic Edition, Revised 5th Edition (The Chemical Society of Japan, Maruzen Publishing)”.

### <Keto Acid>

### <<Specific Keto Acid>>

The water-soluble flux according to the present embodiment contains a keto acid having a melting point of 40° C. or less as a specific keto acid. The keto acid is a compound containing a ketone group and a carboxy group. In the present invention, examples of the specific keto acid include compounds of the following general formula (1).

The melting point of the specific keto acid is preferably 38° C. or less. The melting point of the specific keto acid is preferably 5° C. or more, more preferably 10° C. or more, even more preferably 15° C. or more, particularly preferably 20° C. or more, and most preferably 25° C. or more.

When the melting point of the specific keto acid is the above-mentioned upper limit or less, the fluidity of the flux residue is readily enhanced even at a lower temperature. Thus, voids are readily removed from the flux residue.

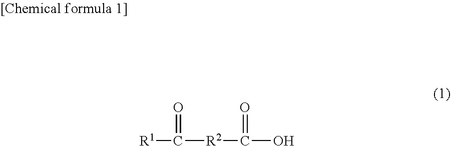

[In the formula, R¹ is a hydrocarbon group which may have a substituent. R² is a hydrocarbon group which may have a substituent or a single bond.]

Examples of the hydrocarbon group as R¹ include C1-20 chained hydrocarbon groups, C3-20 alicyclic hydrocarbon groups, aromatic hydrocarbon groups, and —OR¹¹.

In the case where R¹ is a chained hydrocarbon group, the chained hydrocarbon group may be linear or branched. The chained hydrocarbon group is a saturated hydrocarbon group or an unsaturated hydrocarbon group, and preferably a saturated hydrocarbon group.

In the case where R¹ is an alicyclic hydrocarbon group, the alicyclic hydrocarbon group may be a polycyclic group or a monocyclic group. The monocyclic alicyclic hydrocarbon group is preferably a group obtained by removing at least one hydrogen atom from a monocycloalkane. The polycyclic alicyclic hydrocarbon group is preferably a group obtained by removing at least one hydrogen atom from a polycycloalkane.

Examples of the substituent in R¹ include a carbonyl group, a carboxy group, a hydroxy group, an amino group, and halogen atoms. Examples of the halogen atoms as R¹ include a fluorine atom, a chlorine atom, a bromine atom and an iodine atom.

In the case where R¹ is an aromatic hydrocarbon group, the aromatic hydrocarbon group is a hydrocarbon group having at least one aromatic ring, and examples thereof include: aromatic hydrocarbon rings such as benzene, naphthalene, anthracene, and phenanthrene; aromatic heterocyclic rings in which carbon atoms constituting an aromatic hydrocarbon ring are partially substituted with hetero atoms; and condensed rings in which an aromatic hydrocarbon ring and an aromatic heterocyclic ring are condensed. In the case where an aromatic hydrocarbon group as R¹ has a substituent, examples of the substituent include C1-20 hydrocarbon groups, a carboxy group, a hydroxy group, an amino group, and halogen atoms. In the case where the substituent is a hydrocarbon group, examples of the hydrocarbon group include the same hydrocarbon groups as R¹.

As R¹¹ in-OR¹¹, the same hydrocarbon group as R¹ can be mentioned.

R¹ is preferably a chained hydrocarbon group. The carbon number of the chained hydrocarbon group is preferably 1 to 10, more preferably 1 to 5, even more preferably 1 to 3, and particularly preferably 1. Examples of C1-5 hydrocarbon groups include a methyl group, an ethyl group, a propyl group, an isopropyl group, a n-butyl group, an isobutyl group, a tert-butyl group, a pentyl group, an isopentyl group, and a neopentyl group.

Examples of the hydrocarbon group as R² include C1-20 chained hydrocarbon groups, C3-20 alicyclic hydrocarbon groups, and aromatic hydrocarbon groups. Examples of a substituent in R² include the same groups as R¹ mentioned above.

In the case where R² is a chained hydrocarbon group, the chained hydrocarbon group may be linear or branched. The chained hydrocarbon group is a saturated hydrocarbon group or an unsaturated hydrocarbon group, and preferably a saturated hydrocarbon group.

The linear hydrocarbon group as R² is preferably a linear alkylene group, and specific examples thereof include a methylene group [—CH₂—], an ethylene group [—(CH₂)₂—], a trimethylene group [—(CH₂)₃—], a tetramethylene group [—(CH₂)₄—], and a pentamethylene group [—(CH₂)₅—].

The branched hydrocarbon group as R² is preferably a branched alkylene group, and specific examples thereof include alkyl alkylene groups such as: alkyl methylene groups such as —CH(CH₃)—, —CH(CH₂CH₃)—, —C(CH₃)₂—, —C(CH₃)(CH₂CH₃)—, —C(CH₃)(CH₂CH₂CH₃)—, and —C(CH₂CH₃)₂—; alkyl ethylene groups such as —CH(CH₃)CH₂—, —CH(CH₃)CH(CH₃)—, —C(CH₃)₂CH₂—, —CH(CH₂CH₃)CH₂—, and —C(CH₂CH₃)₂—CH₂—; alkyl trimethylene groups such as —CH(CH₃)CH₂CH₂—, and —CH₂CH(CH₃)CH₂—; and alkyl tetramethylene groups such as —CH(CH₃)CH₂CH₂CH₂—, and —CH₂CH(CH₃)CH₂CH₂—.

In the case where R² is an alicyclic hydrocarbon group, examples of the alicyclic hydrocarbon group include groups obtained by removing one hydrogen atom from an alicyclic hydrocarbon group mentioned above as R¹.

In the case where R² is an aromatic hydrocarbon group, examples of the aromatic hydrocarbon group include groups obtained by removing one hydrogen atom from an aromatic hydrocarbon group mentioned above as R¹.

R² is preferably a chained hydrocarbon group, and more preferably a linear hydrocarbon group.

The carbon number of the chained hydrocarbon group is preferably 1 to 10, more preferably 1 to 5, and even more preferably 1 to 3. As the chained hydrocarbon group, a methylene group, an ethylene group, or a trimethylene group is preferable.

Examples of the specific keto acid include pyruvic acid (melting point: 13.6° C., boiling point: 165° C.), levulinic acid (melting point: 37.2° C., boiling point: 245° C.), 3-oxobutanoic acid (melting point: 36.5° C.), 5-oxohexanoic acid (melting point: 13° C., boiling point: 274° C.), 6-oxoheptanoic acid (melting point: 36° C., boiling point: 335° C.), 7-oxooctanoic acid (melting point: 28° C., boiling point: 370° C.), 2-oxobutanoic acid (melting point: 32° C., boiling point: 208° C.), and 2-oxopentanoic acid (melting point: 7° C., boiling point: 230° C.).

One of the specific keto acids may be used alone, or at least two thereof may be mixed and used.

The specific keto acid preferably contains an organic acid having one carboxy group in a molecule thereof. Thus, the generation of voids can be further readily suppressed.

The specific keto acid preferably contains at least one selected from the group consisting of a pyruvic acid and a levulinic acid, and more preferably contains a levulinic acid.

The boiling point (Tk) of the specific keto acid is preferably 150° C. or more, more preferably 200° C. or more, particularly preferably 220° C. or more, and most preferably 230° C. or more. When the Tk is the above-mentioned lower-limit or more, the complete volatilization of the specific keto acid during reflow can be readily suppressed. In addition, the specific solvent is likely to volatilize earlier than the specific keto acid. Therefore, during reflow, the specific keto acid volatilizes together with the solvent that has already started to volatilize. As a result, during reflow, bubbles (voids) generated by volatilization of the solvent and the specific keto acid coalesce together and become larger, thereby making it easier to discharge the voids from a solder paste. Namely, the generation of voids is likely to be further suppressed during reflow.

The Tk is preferably 280° C. or lower, more preferably 270° C. or lower, even more preferably 260° C. or lower, and particularly preferably 250° C. or lower. When the Tk is the above-mentioned upper limit or less, the specific keto acid is likely to volatilize together with the solvent during reflow. As a result, during reflow, voids generated by volatilization of the solvent and the specific keto acid coalesce together and become larger, thereby making it easier to discharge the voids from the solder paste. Namely, the generation of voids is likely to be further suppressed during reflow.

The Tk is preferably 150° C. to 280° C., more preferably 200° C. to 270° C., even more preferably 220° C. to 260° C., and particularly preferably 230° C. to 250° C.

### <<Other Keto Acids>>

The water-soluble flux according to the present embodiment may contain a keto acid having a melting point exceeding 40° C. as another keto acid.

Examples of other keto acids include oxaloacetic acid (melting point: 161° C.), α-ketoglutaric acid (melting point: 113.5° C.), acetonedicarboxylic acid (melting point: 138° C.), α-ketoadipic acid (melting point: 127° C.), and β-ketoadipic acid (melting point: 124° C.-126° C.).

One of the other keto acids may be used alone, or at least two thereof may be mixed and used.

In the flux, the amount of the specific keto acid relative to the total mass (100% by mass) of the flux is preferably 5% by mass or more, more preferably 10% by mass or more, and even more preferably 15% by mass or more. The amount is preferably 30% by mass or less, more preferably 25% by mass or less, and even more preferably 20% by mass or less.

In the flux, the amount of the specific keto acid relative to the total mass (100% by mass) of the flux may be 10% by mass to 25% by mass, 15% by mass to 25% by mass, or 15% by mass to 20% by mass, for example.

In the flux, the amount of the specific keto acid relative to the total mass (100% by mass) of the keto acid is preferably 90% by mass or more and more preferably 100% by mass.

When the amount of the specific keto acid is the above-mentioned lower-limit or more, the generation of voids is likely to be further suppressed. When the amount of the specific keto acid is the above-mentioned upper limit or less, the storage stability of the flux over time is likely to be enhanced.

### <Solvent>

### <<Specific Solvent>>

The water-soluble flux according to the present embodiment contains a solvent (S1) having a boiling point of 240° C. or less as a specific solvent. Although the lower limit of the boiling point of the specific solvent is not particularly limited, the lower limit may be 150° C. or more, for example.

Examples of the specific solvent include: water; glycol ether-based solvents having a boiling point of 240° C. or less; terpineols having a boiling point of 240° C. or less; alcohol-based solvents having a boiling point of 240° C. or less; and ester-based solvents having a boiling point of 240° C. or less.

Examples of the glycol ether-based solvents having a boiling point of 240° C. or less include phenyl glycol (boiling point 237° C.: ethylene glycol monophenyl ether), butyl carbitol (boiling point 231° C.: diethylene glycol monobutyl ether), and hexylene glycol (boiling point 197° C.: 2-methylpentane-2,4-diol).

Examples of the terpineols having a boiling point of 240° C. or less include α-terpineol (boiling point 217° C.).

Examples of the alcohol-based solvents having a boiling point of 240° C. or less include ethanol (boiling point 78° C.), 1-propanol (boiling point 97° C.), 2-propanol (boiling point 82° C.), 1,2-butanediol (boiling point 192° C.), 2,2-dimethyl-1,3-propanediol (boiling point 210° C.), 2,5-dimethyl-2,5-hexanediol (boiling point 215° C.), 2,5-dimethyl-3-hexyne-2,5-diol (boiling point 206° C.), 2,3-dimethyl-2,3-butanediol (boiling point 174° C.), 2-methylpentane-2,4-diol (boiling point 197° C.), and 1-ethynyl-1-cyclohexanol (boiling point 180° C.).

One of the specific solvents may be used alone, or at least two thereof may be mixed and used.

The specific solvent preferably contains at least one selected from the group consisting of the glycol ether-based solvents having a boiling point of 240° C. or less, the terpineols having a boiling point of 240° C. or less, the alcohol-based solvents having a boiling point of 240° C. or less, and the ester-based solvents having a boiling point of 240° C. or less, and more preferably contains at least one selected from the group consisting of the glycol ether-based solvents having a boiling point of 240° C. or less, and the terpineols having a boiling point of 240° C. or less.

The specific solvent more preferably contains at least one selected from the group consisting of phenyl glycol, hexylene glycol, and α-terpineol, and even more preferably contains α-terpineol.

The boiling point (Ts) of the specific solvent is preferably 150° C. or more, more preferably 180° C. or more, even more preferably 190° C. or more, particularly preferably 200° C. or more, and most preferably 210° C. or more. When the Ts is the above-mentioned lower-limit or more, the generation of voids is likely to be further suppressed.

The Ts is 240° C. or less, preferably 235° C. or less, more preferably 230° C. or less, and even more preferably 225° C. or less. When the Ts is the above-mentioned upper limit or less, the generation of voids is likely to be further suppressed.

The Ts is preferably 150° C. to 240° C., more preferably 180° C. to 235° C., even more preferably 200° C. to 230° C., and particularly preferably 210° C. to 225° C.

The absolute value of the temperature difference ΔT between Tk and Ts is preferably 0° C. or more, more preferably 3° C. or more, and even more preferably 5° C. or more.

When the ΔT is the above-mentioned lower-limit or more, the generation of voids is likely to be further suppressed.

The ΔT is preferably 70° C. or less, more preferably 60° C. or less and even more preferably 55° C. or less.

When the ΔT is the above-mentioned upper limit or less, the generation of voids is likely to be further suppressed.

In addition, Tk and Ts preferably satisfy the relationship of Ts<Tk.

When the relationship of Ts<Tk is satisfied, the ΔT is preferably 5° C. to 50° C., more preferably 10° C. to 45° C., even more preferably 15° C. to 40° C., and particularly preferably 20° C. to 35° C.

When the ΔT is within the above-mentioned range, the generation of voids is likely to be further suppressed.

### <<Other Solvents>>

The water-soluble flux according to the present embodiment may contain another solvent (namely, a solvent other than a specific solvent).

Examples of other solvents include glycol ether-based solvents having a boiling point exceeding 240° C., alcohol-based solvents having a boiling point exceeding 240° C., and ester-based solvents having a boiling point exceeding 240° C.

Examples of the glycol ether-based solvents having a boiling point exceeding 240° C. include diethylene glycol monohexyl ether (boiling point 258° C.), diethylene glycol mono-2-ethylhexyl ether (boiling point 272° C.), diethylene glycol dibutyl ether (boiling point 256° C.), triethylene glycol monobutyl ether (boiling point 278° C.), triethylene glycol butylmethyl ether (boiling point 261° C.), tetraethylene glycol dimethyl ether (boiling point 275° C.), and tripropylene glycol monomethyl ether (boiling point 243° C.).

Examples of the alcohol-based solvents having a boiling point exceeding 240° C. include 2,4-diethyl-1,5-pentanediol (boiling point 264° C.), 2-ethyl-2-hydroxymethyl-1,3-propanediol (boiling point 292° C.), 2,2′-oxybis(methylene)bis(2-ethyl-1,3-propanediol) (boiling point 448° C.), 1,2,6-trihydroxyhexane (boiling point 386° C.), 1,4-cyclohexanediol (boiling point 293° C.), 1,4-cyclohexane dimethanol (boiling point 283° C.), 2,4,7,9-tetramethyl-5-decyne-4,7-diol (boiling point 255° C.), 2,2-bis(hydroxymethyl)-1,3-propanediol (boiling point 437° C.), and isobornyl cyclohexanol (boiling point 318° C.).

Examples of the ester-based solvents having a boiling point exceeding 240° C. include bis(2-ethylhexyl) sebacate (boiling point 377° C.).

One of the other solvents may be used alone, or at least two thereof may be mixed and used.

In the flux, the amount of the specific solvent relative to the total mass (100% by mass) of the flux is preferably 10% by mass to 70% by mass, more preferably 15% by mass to 60% by mass, and even more preferably 15% by mass to 50% by mass.

In the flux, the amount of the specific solvent relative to the total mass (100% by mass) of the solvent is preferably 90% by mass or more, and more preferably 100% by mass.

When the amount of the specific solvent is the above-mentioned lower-limit or more, the generation of voids is likely to be further suppressed.

The mixing ratio of the specific solvent to the specific keto acid is preferably 0.60 to 4.0, more preferably 0.60 to 3.0, and even more preferably 0.60 to 2.5, as the mass ratio indicated by specific solvent/specific keto acid, namely, the ratio of the specific solvent amount to the specific keto acid amount.

When the mixing ratio is within the above-mentioned preferable range, the generation of voids is likely to be further suppressed.

### <Other Components>

The flux according to the present embodiment may contain, as needed, other components, in addition to the keto acid and the solvent.

Examples of other components include: organic acids other than the keto acids; amines; other activators such as halogen compounds; surfactants; metal deactivators; silane coupling agents; antioxidants; and colorants.

[Organic Acids Other than Keto Acids]

Examples of organic acids other than the keto acids include carboxylic acids, and organic sulfonic acids.

Examples of the carboxylic acids include aliphatic carboxylic acids and aromatic carboxylic acids.

Examples of the carboxylic acids include oxalic acid, malonic acid, succinic acid, glutaric acid, adipic acid, azelaic acid, eicosanedioic acid, salicylic acid, dipicolinic acid, dibutyl aniline diglycolic acid, suberic acid, sebacic acid, terephthalic acid, dodecanedioic acid, parahydroxyphenylacetic acid, picolinic acid, phenylsuccinic acid, phthalic acid, lauric acid, benzoic acid, tartaric acid, tris(2-carboxyethyl) isocyanurate, 1,3-cyclohexanedicarboxylic acid, 2,2-bis(hydroxymethyl)propionic acid, 2,2-bis(hydroxymethyl) butanoic acid, 2,3-dihydroxybenzoic acid, 2,4-diethylglutaric acid, 2-quinolinecarboxylic acid, 3-hydroxybenzoic acid, p-anisic acid, stearic acid, 12-hydroxystearic acid, oleic acid, linoleic acid, linolenic acid, myristic acid, palmitic acid, pimelic acid, caproic acid, enanthic acid, caprylic acid, pelargonic acid, isopelargonic acid, capric acid, caproleic acid, undecanoic acid, lauric acid, linderic acid, tridecanoic acid, myristoleic acid, pentadecanoic acid, isopalmitic acid, palmitoleic acid, hiragonic acid, hydnocarpic acid, margaric acid, isostearic acid, elaidic acid, petroselinic acid, moroctic acid, eleostearic acid, tariric acid, vaccenic acid, ricinoleic acid, vernolic acid, sterculynic acid, nonadecanoic acid, eicosanoic acid, dimer acid, trimer acid, hydrogenated dimer acid which is a hydrogenated product formed by adding hydrogen to dimer acid, and hydrogenated trimer acid which is a hydrogenated product formed by adding hydrogen to trimer acid.

Examples of the dimer acid and the trimer acid include a dimer acid which is a reaction product of an oleic acid and a linoleic acid, a trimer acid which is a reaction product of an oleic acid and a linoleic acid, a dimer acid which is a reaction product of an acrylic acid, a trimer acid which is a reaction product of an acrylic acid, a dimer acid which is a reaction product of methacrylic acid, a trimer acid which is a reaction product of methacrylic acid, a dimer acid which is a reaction product of an acrylic acid and methacrylic acid, a trimer acid which is a reaction product of an acrylic acid and methacrylic acid, a dimer acid which is a reaction product of an oleic acid, a trimer acid which is a reaction product of an oleic acid, a dimer acid which is a reaction product of linoleic acid, a trimer acid which is a reaction product of linoleic acid, a dimer acid which is a reaction product of linolenic acid, a trimer acid which is a reaction product of linolenic acid, a dimer acid which is a reaction product of an acrylic acid and an oleic acid, a trimer acid which is a reaction product of an acrylic acid and an oleic acid, a dimer acid which is a reaction product of an acrylic acid and a linoleic acid, a trimer acid which is a reaction product of an acrylic acid and a linoleic acid, a dimer acid which is a reaction product of an acrylic acid and a linolenic acid, a trimer acid which is a reaction product of an acrylic acid and linolenic acid, a dimer acid which is a reaction product of methacrylic acid and an oleic acid, a trimer acid which is a reaction product of methacrylic acid and an oleic acid, a dimer acid which is a reaction product of methacrylic acid and a linoleic acid, a trimer acid which is a reaction product of methacrylic acid and a linoleic acid, a dimer acid which is a reaction product of methacrylic acid and linolenic acid, a trimer acid which is a reaction product of methacrylic acid and linolenic acid, a dimer acid which is a reaction product of an oleic acid and linolenic acid, a trimer acid which is a reaction product of an oleic acid and a linolenic acid, a dimer acid which is a reaction product of linoleic acid and linolenic acid, a trimer acid which is a reaction product of linoleic acid and linolenic acid, a hydrogenated dimer acid which is a hydrogenated product of each of the above-mentioned dimer acids, and a hydrogenated trimer acid which is a hydrogenated product of each of the above-mentioned trimer acid.

For example, a dimer acid which is a reaction product of an oleic acid and a linoleic acid is a dimer having 36 carbon atoms. Furthermore, a trimer acid which is a reaction product of an oleic acid and a linoleic acid is a trimer having 54 carbon atoms.

Examples of the organic sulfonic acid include aliphatic sulfonic acids and aromatic sulfonic acids. Examples of the aliphatic sulfonic acid include alkane sulfonic acids and alkanol sulfonic acids.

Examples of the alkane sulfonic acids include methanesulfonic acid, ethanesulfonic acid, 1-propanesulfonic acid, 2-propanesulfonic acid, 1-butanesulfonic acid, 2-butanesulfonic acid, pentanesulfonic acid, hexanesulfonic acid, decanesulfonic acid, and dodecanesulfonic acid.

Examples of the alkanol sulfonic acids include 2-hydroxyethane-1-sulfonic acid, 2-hydroxypropane-1-sulfonic acid, 2-hydroxybutane-1-sulfonic acid, 2-hydroxypentane-1-sulfonic acid, 1-hydroxypropane-2-sulfonic acid, 3-hydroxypropane-1-sulfonic acid, 4-hydroxybutane-1-sulfonic acid, 2-hydroxyhexane-1-sulfonic acid, 2-hydroxydecane-1-sulfonic acid and 2-hydroxydodecane-1-sulfonic acid.

Examples of the aromatic sulfonic acids include 1-naphthalenesulfonic acid, 2-naphthalenesulfonic acid, p-toluenesulfonic acid, xylenesulfonic acid, p-phenolsulfonic acid, cresolsulfonic acid, sulfosalicylic acid, nitrobenzenesulfonic acid, sulfobenzoic acid and diphenylamine-4-sulfonic acid.

One of the organic acids other than the keto acids may be used alone or at least two thereof may be mixed and used.

The organic acids other than the keto acids preferably contain at least one selected from the group consisting of the carboxylic acids and the organic sulfonic acids. The carboxylic acids preferably contain an aliphatic dicarboxylic acid, and more preferably contain a glutaric acid. The organic sulfonic acids preferably contain an aromatic sulfonic acid, and more preferably contain a p-toluenesulfonic acid.

In the flux, the amount of the organic acids other than the keto acids relative to the total mass (100% by mass) of the flux is preferably 1% by mass to 10% by mass, and more preferably 2% by mass to 6% by mass.

In the flux, the amount of the specific keto acid relative to the total mass (100% by mass) of the organic acids is preferably 75% by mass or more, more preferably 80% by mass or more, and even more preferably 85% by mass or more. Although the upper limit of the amount of the specific keto acid is not particularly limited, the upper limit may be 100% by mass.

When the amount of the specific keto acid is the above-mentioned lower-limit or more, the generation of voids is likely to be further suppressed.

### [Amine]

Examples of the amine include azoles, guanidines, alkylamine compounds, aminoalcohol compounds, and amine polyoxyalkylene adducts.

Examples of the azoles include 2-methylimidazole, 2-ethylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, 2,4-diamino-6-[2′-methylimidazolyl-(1′)]-ethyl-s-triazine isocyanuric acid adducts, 2-phenylimidazole isocyanuric acid adducts, 2-phenyl-4,5-dihydroxymethylimidazole, 2-phenyl-4-methyl-5-hydroxymethylimidazole, 2,3-dihydro-1H-pyrrolo[1,2-a]benzimidazole, 1-dodecyl-2-methyl-3-benzylimidazolium chloride, 2-methylimidazoline, 2-phenylimidazoline, 2,4-diamino-6-vinyl-s-triazine, 2,4-diamino-6-vinyl-s-triazine isocyanuric acid adducts, 2,4-diamino-6-methacryloyloxyethyl-s-triazine, epoxy-imidazole adducts, 2-methylbenzimidazole, 2-octylbenzimidazole, 2-pentylbenzimidazole, 2-(1-ethylpentyl)benzimidazole, 2-nonylbenzimidazole, 2-(4-thiazolyl)benzimidazole, benzimidazole, 1,2,4-triazole, 2-(2′-hydroxy-5′-methylphenyl)benzotriazole, 2-(2′-hydroxy-3′-tert-butyl-5′-methylphenyl)-5-chlorobenzotriazole, 2-(2′-hydroxy-3′,5′-di-tert-amylphenyl)benzotriazole, 2-(2′-hydroxy-5′-tert-octylphenyl)benzotriazole, 2,2′-methylenebis[6-(2H-benzotriazol-2-yl)-4-tert-octylphenol], 6-(2-benzotriazolyl)-4-tert-octyl-6′-tert-butyl-4′-methyl-2,2′-methylenebisphenol, 1,2,3-benzotriazole, 1-[N,N-bis(2-ethylhexyl)aminomethyl]benzotriazole, carboxybenzotriazole, 1-[N,N-bis(2-ethylhexyl)aminomethyl]methylbenzotriazole, 2,2′-[[(methyl-1H-benzotriazol-1-yl)methyl]imino]bisethanol, 1-(1′,2′-dicarboxyethyl)benzotriazole, 1-(2,3-dicarboxypropyl)benzotriazole, 1-[(2-ethylhexylamino)methyl]benzotriazole, 2,6-bis[(1H-benzotriazol-1-yl)methyl]-4-methylphenol, 5-methylbenzotriazole, and 5-phenyltetrazole.

Examples of the guanidines include 1,3-diphenylguanidine, 1,3-di-o-tolylguanidine, 1-o-tolylbiguanide, 1,3-di-o-cumenylguanidine, and 1,3-di-o-cumenyl-2-propionylguanidine.

Examples of the alkylamine compounds include ethylamine, triethylamine, ethylenediamine, triethylenetetramine, cyclohexylamine, hexadecylamine, and stearylamine.

Examples of the aminoalcohol compounds include monoisopropanolamine.

Examples of the amine polyoxyalkylene adducts include diamine-terminated polyalkylene glycols, aliphatic amine polyoxyalkylene adducts, aromatic amine polyoxyalkylene adducts, and polyvalent amine polyoxyalkylene adducts.

Examples of an alkylene oxide from which an amine polyoxyalkylene adduct is derived include ethylene oxide, propylene oxide, and butylene oxide.

The diamine-terminated polyalkylene glycol is a compound in which both terminals of a polyalkylene glycol are aminated.

Examples of the diamine-terminated polyalkylene glycol include diamine-terminated polyethylene glycol, diamine-terminated polypropylene glycol, and diamine-terminated polyethylene glycol-polypropylene glycol copolymers.

Examples of the diamine-terminated polyethylene glycol-polypropylene glycol copolymers include polyethylene glycol-polypropylene glycol copolymer bis(2-aminopropyl) ether, and polyethylene glycol-polypropylene glycol copolymer bis(2-aminoethyl) ether.

The aliphatic amine polyoxyalkylene adducts, the aromatic amine polyoxyalkylene adducts, and the polyvalent amine polyoxyalkylene adducts are compounds each in which a polyoxyalkylene group is bonded to a nitrogen atom of an amine. Examples of the amine include ethylene diamine, 1,3-propane diamine, 1,4-butane diamine, hexamethylene diamine, lauryl amine, stearyl amine, oleyl amine, beef fat amine, hardened beef fat amine, beef fat propyl diamine, m-xylene diamine, diethylene triamine, meta-xylene diamine, tolylene diamine, para-xylene diamine, phenylene diamine, isophorone diamine, 1,10-decane diamine, 1,12-dodecane diamine, 4,4-diaminodicyclohexylmethane, 4,4-diaminodiphenylmethane, butane-1,1,4,4-tetraamine, and pyrimidine-2,4,5,6-tetraamine.

Examples of the aliphatic amine polyoxyalkylene adducts include polyoxyalkylene alkyl amines. Examples of the polyoxyalkylene alkyl amines include polyoxyalkylene ethylene diamines. The polyoxyalkylene ethylene diamine is a compound in which at least one polyoxyalkylene group is bonded to any of nitrogen atoms of an ethylene diamine. Examples of the polyoxyalkylene ethylene diamines include polyoxyethylene ethylene diamine, polyoxypropylene ethylene diamine, and polyoxyethylene polyoxypropylene ethylene diamine. The polyoxyethylene ethylene diamine is a compound in which at least one polyoxyethylene group is bonded to any of nitrogen atoms of an ethylene diamine, and the polyoxypropylene ethylene diamine is a compound in which at least one polyoxypropylene group is bonded to any of nitrogen atoms of an ethylene diamine. The polyoxyethylene polyoxypropylene ethylene diamine is a compound in which at least one of polyoxypropylene groups and polyoxyethylene groups is bonded to any of nitrogen atoms of an ethylene diamine.

Examples of the polyoxyalkylene ethylene diamine include N-polyoxypropylene ethylene diamine, N-polyoxyethylene ethylene diamine, N-polyoxyethylene polyoxypropylene ethylene diamine, N,N,N′,N′-tetrakis(2-hydroxyethyl)ethylene diamine, and N,N,N′,N′-tetrakis(2-hydroxypropyl)ethylene diamine.

One of the amines may be used alone, or at least two thereof may be mixed and used.

As the amine, at least one selected from the group consisting of azoles, alkylamine compounds and amine polyoxyalkylene adducts is preferably contained.

As the azole, 2-ethylimidazole is preferably contained.

As the alkylamine compounds, triethylene tetramine is preferably contained.

As the amine polyoxyalkylene adducts, diamine-terminated polyalkylene glycols and/or aliphatic amine polyoxyalkylene adducts are preferably contained.

As the aliphatic amine polyoxyalkylene adducts, polyoxyalkylene ethylene diamine is preferably contained, and N,N,N′,N′-tetrakis(2-hydroxypropyl)ethylene diamine is more preferably contained.

As the diamine-terminated polyalkylene glycol, diamine-terminated polyethylene glycol-polypropylene glycol copolymer is preferably contained.

The total amount of the azole and the alkylamine compounds relative to the total mass (100% by mass) of the flux is preferably 0.5% by mass to 6% by mass, and more preferably 1% by mass to 4% by mass.

The amount of the aliphatic amine polyoxyalkylene adducts relative to the total mass (100% by mass) of the flux is preferably 10% by mass to 40% by mass, and more preferably 15% by mass to 30% by mass.

### [Halogen Compound]

Examples of the halogen compound include amine hydrohalic acid salts, and organic halogen compounds other than the amine hydrohalic acid salts.

The amine hydrohalic acid salt is a compound obtained by reacting an amine and hydrogen halide.

Examples of the amine include aliphatic amines, azoles, and guanidines. Examples of the hydrogen halide include hydrogenated products such as chlorinated, brominated or iodinated products.

Examples of the aliphatic amines include ethylamine, diethylamine, triethylamine, and ethylene diamine.

Examples of the guanidines and azoles include the same compounds mentioned as the amines.

More specific examples of the amine hydrohalic acid salts include cyclohexylamine hydrobromide, hexadecylamine hydrobromide, stearylamine hydrobromide, ethylamine hydrobromide, diphenylguanidine hydrobromide, ethylamine hydrochloride, stearylamine hydrochloride, diethylaniline hydrochloride, diethanolamine hydrochloride, 2-ethylhexylamine hydrobromide, pyridine hydrobromide, isopropylamine hydrobromide, diethylamine hydrobromide, dimethylamine hydrobromide, dimethylamine hydrochloride, rosin amine hydrobromide, 2-ethylhexylamine hydrochloride, isopropylamine hydrochloride, cyclohexylamine hydrochloride, 2-pipecoline hydrobromide, 1,3-diphenylguanidine hydrochloride, dimethylbenzylamine hydrochloride, hydrazine hydrate hydrobromide, dimethylcyclohexylamine hydrochloride, trinonylamine hydrobromide, diethylaniline hydrobromide, 2-diethylaminoethanol hydrobromide, 2-diethylaminoethanol hydrochloride, ammonium chloride, diallylamine hydrochloride, diallylamine hydrobromide, diethylamine hydrochloride, triethylamine hydrobromide, triethylamine hydrochloride, hydrazine monohydrochloride, hydrazine dihydrochloride, hydrazine monohydrobromide, hydrazine dihydrobromide, pyridine hydrochloride, aniline hydrobromide, butylamine hydrochloride, hexylamine hydrochloride, n-octylamine hydrochloride, dodecylamine hydrochloride, dimethylcyclohexylamine hydrobromide, ethylenediamine dihydrobromide, rosin amine hydrobromide, 2-phenylimidazole hydrobromide, 4-benzylpyridine hydrobromide, L-glutamic acid hydrochloride, N-methylmorpholine hydrochloride, betaine hydrochloride, 2-pipecoline hydroiodide, cyclohexylamine hydroiodide, 1,3-diphenylguanidine hydrofluoride, diethylamine hydrofluoride, 2-ethylhexylamine hydrofluoride, cyclohexylamine hydrofluoride, ethylamine hydrofluoride, rosin amine hydrofluoride, cyclohexylamine tetrafluoroborate, and dicyclohexylamine tetrafluoroborate.

Furthermore, as the halogen compound, for example, a salt obtained by reacting an amine with tetrafluoroboric acid (HBF₄), and a complex obtained by reacting an amine with boron trifluoride (BF₃) can also be used.

Examples of the complex include boron trifluoride piperidine.

Examples of the organic halogen compounds other than the amine hydrohalic acid salts include halogenated aliphatic compounds. A halogenated aliphatic hydrocarbon group is a group formed by partially or entirely substituting hydrogen atoms constituting an aliphatic hydrocarbon group with halogen atoms.

Examples of the halogenated aliphatic compounds include halogenated aliphatic alcohols, and halogenated heterocyclic compounds.

Examples of the halogenated aliphatic alcohols include 1-bromo-2-propanol, 3-bromo-1-propanol, 3-bromo-1,2-propanediol, 1-bromo-2-butanol, 1,3-dibromo-2-propanol, 2,3-dibromo-1-propanol, 1,4-dibromo-2-butanol, and trans-2,3-dibromo-2-butene-1,4-diol.

Examples of the halogenated heterocyclic compounds include compounds of the following general formula (2).

R²¹—(R²²)ₙ (2)

[In the formula, R²¹ is an n-valent heterocyclic group. R²² is a halogenated aliphatic hydrocarbon group.]

Examples of a hetero ring of the n-valent heterocyclic group as R²¹ include a ring structure formed by partially substituting carbon atoms constituting an aliphatic hydrocarbon or an aromatic hydrocarbon ring with hetero atoms. Examples of the hetero atom in the hetero ring include an oxygen atom, a sulfur atom and a nitrogen atom. The hetero ring is preferably a three- to ten-membered ring, and more preferably a five- to seven-membered ring. Examples of the hetero ring include an isocyanurate ring.

The carbon number of the halogenated aliphatic hydrocarbon group as R²² is preferably one to ten, more preferably two to six, and even more preferably three to five. R²² is preferably a brominated aliphatic hydrocarbon group or a chlorinated aliphatic hydrocarbon group, more preferably a brominated aliphatic hydrocarbon group, and even more preferably a brominated saturated aliphatic hydrocarbon group.

Examples of the halogenated heterocyclic compound include tris-(2,3-dibromopropyl) isocyanurate.

Examples of the organic halogen compound other than the amine hydrohalic acid salts include halogenated carboxyl compounds such as iodized carboxyl compounds such as 2-iodobenzoic acid, 3-iodobenzoic acid, 2-iodopropionic acid, 5-iodosalicylic acid, and 5-iodoanthranilic acid; chlorinated carboxyl compounds such as 2-chlorobenzoic acid, and 3-chloropropionic acid; and brominated carboxyl compounds such as 2,3-dibromopropionic acid, 2,3-dibromosuccinic acid, and 2-bromobenzoic acid.

One of the halogen compounds may be used alone or at least two thereof may be mixed and used.

### <<Surfactant>>

Examples of the surfactant include nonionic surfactants.

Examples of the nonionic surfactants include polyalkylene glycols.

Examples of an alkylene oxide, from which the polyalkylene glycol is derived, include ethylene oxide, propylene oxide, and butylene oxide.

Examples of the polyalkylene glycols include polyethylene glycol, ethylene oxide-resorcinol copolymers, polyoxyalkylene acetylene glycols, polyoxyalkylene glyceryl ethers, polyoxyalkylene alkyl ethers, polyoxyalkylene esters, and polyoxyalkylene alkyl amides.

Additional examples of the nonionic surfactants include polyoxyalkylene adducts of alcohols. Examples of the alcohols include aliphatic alcohols, aromatic alcohols, and polyvalent alcohols.

One of the surfactants may be used alone or at least two thereof may be mixed and used.

The water-soluble flux according to the present embodiment preferably contains a surfactant.

As the surfactant, a nonionic surfactant is preferably contained, and at least one selected from the group consisting of ethylene oxide-resorcinol copolymers and aliphatic alcohol polyoxyalkylene adducts is more preferably contained.

The amount of the surfactant relative to the total mass (100% by mass) of the flux is preferably 5% by mass to 75% by mass, more preferably 5% by mass to 65% by mass, and even more preferably 5% by mass to 30% by mass.

### <<Metal Deactivators>>

Examples of the metal deactivator include hindered phenol-based compounds, and nitrogen compounds.

The term “metal deactivator” refers to a compound that prevents metal from deteriorating when brought in contact with a certain compound.

The hindered phenol-based compound is a phenol-based compound having a bulky substituent (such as a branched alkyl group such as a t-butyl group or a cyclic alkyl group) on at least one of ortho positions of a phenol.

Although the hindered phenol-based compound is not particularly limited, examples thereof include bis[3-(3-tert-butyl-4-hydroxy-5-methylphenyl)propionic acid][ethylenebis(oxyethylene)], N,N′-hexamethylenebis[3-(3,5-di-tert-butyl-4-hydroxyphenyl)propaneamide], 1,6-hexanediolbis[3-(3,5-di-tert-butyl-4-hydroxyphenyl)propionate], 2,2′-methylenebis[6-(1-methylcyclohexyl)-p-cresol], 2,2′-methylenebis(6-tert-butyl-p-cresol), 2,2′-methylenebis(6-tert-butyl-4-ethylphenol), triethylene glycol-bis[3-(3-tert-butyl-5-methyl-4-hydroxyphenyl)propionate], 1,6-hexanediol-bis-[3-(3,5-di-tert-butyl-4-hydroxyphenyl)propionate], 2,4-bis-(n-octylthio)-6-(4-hydroxy-3,5-di-t-butylanilino)-1,3,5-triazine, pentaerythrityl-tetrakis[3-(3,5-di-tert-butyl-4-hydroxyphenyl)propionate], 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-t-butyl-4-hydroxy-hydrocinnamamide), 3,5-di-tert-butyl-4-hydroxybenzylphosphonate-diethyl esters, 1,3,5-trimethyl-2,4,6-tris(3,5-di-tert-butyl-4-hydroxybenzyl)benzene, N,N′-bis[2-[2-(3,5-di-tert-butyl-4-hydroxyphenyl)ethylcarbonyloxy]ethyl]oxamide, and compounds of the following general formula (3).

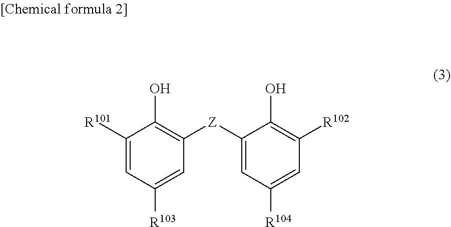

(In the formula, Z is an alkylene group which may have a substituent. R¹⁰¹ and R¹⁰² are each independently an alkyl group, an aralkyl group, an aryl group, a heteroaryl group, a cycloalkyl group or a heterocycloalkyl group, which may have a substituent. R¹⁰³ and R¹⁰⁴ are each independently an alkyl group which may have a substituent.)

Examples of the nitrogen compound as the metal deactivator include hydrazide-based nitrogen compounds, amide-based nitrogen compounds, triazole-based nitrogen compounds and melamine-based nitrogen compounds.

The hydrazide-based nitrogen compound may be a nitrogen compound having a hydrazide skeleton, and examples thereof include dodecanedioic acid bis[N2-(2hydroxybenzoyl) hydrazide], N,N′-bis[3-(3,5-di-tert-butyl-4-hydroxyphenyl)propionyl]hydrazine, decanedicarboxylic acid disalicyloylhydrazide, N-salicylidene-N′-salicylhydrazide, m-nitrobenzhydrazide, 3-aminophthalhydrazide, phthalic acid dihydrazide, adipic acid hydrazide, oxalobis(2-hydroxy-5-octylbenzylidenehydrazide), N′-benzoylpyrrolidone carboxylic acid hydrazide, and N,N′-bis(3-(3,5-di-tert-butyl-4-hydroxyphenyl)propionyl) hydrazine.

The amide-based nitrogen compound may be a nitrogen compound having an amide skeleton, and examples thereof include N,N′-bis {2-[3-(3,5-di-tert-butyl-4-hydroxyphenyl)propionyloxyl]ethyl}oxamide.

The triazole-based nitrogen compound may be a nitrogen compound having a triazole skeleton, and examples thereof include N-(2H-1,2,4-triazol-5-yl) salicylamide, 3-amino-1,2,4-triazole, and 3-(N-salicyloyl)amino-1,2,4-triazole.

The melamine-based nitrogen compound may be a nitrogen compound having a melamine skeleton, and examples thereof include melamine, and melamine derivatives. Specific examples thereof include trisaminotriazine, alkylated trisaminotriazine, alkoxyalkylated trisaminotriazine, melamine, alkylated melamine, alkoxyalkylated melamine, N2-butylmelamine, N2,N2-diethylmelamine, and N,N,N′,N′,N″,N″-hexakis(methoxymethyl)melamine.

One of the metal deactivators may be used alone or at least two thereof may be mixed and used.

It is preferable that any resin components be absent in the flux according to the present embodiment. In the present specification, examples of the resin components include rosins and resins other than rosins.

In the present specification, the term “rosin” encompasses: natural resins including a mixture of an abietic acid as the main component and isomers thereof; and ones obtained by chemically modifying natural resins (which may be referred to as rosin derivatives).

In the natural resin, the amount of the abietic acid relative to the natural resin is 40% by mass to 80% by mass, for example.

In the present specification, the term “main component” refers to a component the amount of which in a compound relative to the total mass of components constituting the compound is 40% by mass or more.

Representative examples of the isomer of the abietic acid include neoabietic acid, palustric acid, and levopimaric acid. The structure of the abietic acid is shown below.

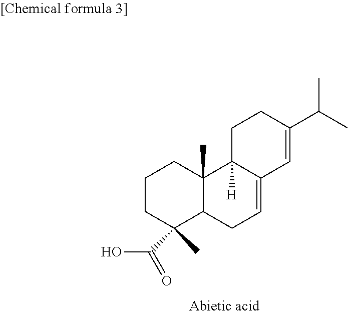

Examples of the “natural resin” include gum rosin, wood rosin and tall oil rosin.

In the present invention, the term “ones obtained by chemically modifying natural resins (rosin derivatives)” encompasses those obtained by subjecting the above-mentioned “natural resin” to one or more treatments selected from the group consisting of hydrogenation, dehydrogenation, neutralization, alkylene oxide addition, amidation, dimerization, multimerization, esterification, and Diels-Alder cycloaddition.

Examples of the rosin derivatives include purified rosins and modified rosins.

Examples of the modified rosins include: hydrogenated rosins; polymerized rosins; polymerized hydrogenated rosins; heterogeneous rosins; acid-modified rosins; rosin esters; acid-modified hydrogenated rosins; anhydrous acid-modified hydrogenated rosins; acid-modified heterogeneous rosins; anhydrous acid-modified heterogeneous rosins; phenol-modified rosins; α,β unsaturated carboxylic acid-modified products (such as acrylated rosins, maleated rosins, and fumarated rosins); purified products, hydrogenated products and heterogeneous products of the polymerized rosin; purified products, hydrogenated products and heterogeneous products of the α,β unsaturated carboxylic acid-modified products; rosin alcohols; rosin amines; hydrogenated rosin alcohols; rosin esters; hydrogenated rosin esters; rosin soaps; hydrogenated rosin soaps; and acid-modified rosin soaps.

Examples of the rosin amine include dehydroabietylamine, and dihydroabietylamine. The term “rosin amine” means a so-called heterogeneous rosin amine. Each structure of dehydroabietylamine and dihydroabietylamine is shown below.

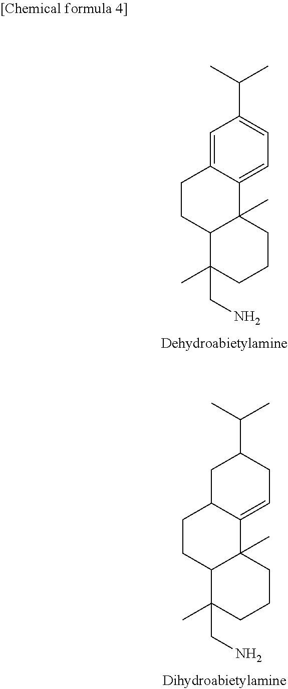 [SMILES: CC(C)c1ccc2c(c1)CCC1C(C)(CN)CCCC21C ; CC(C)C1CC=C2C(CCC3C(C)(CN)CCCC23C)C1]

Examples of resins other than the rosins include terpene resin, modified terpene resin, terpene phenol resin, modified terpene phenol resin, styrene resin, modified styrene resin, xylene resin, modified xylene resin, acrylic resin, polyethylene resin, acryl-polyethylene copolymer resin, and other thermosetting resin.

Examples of the modified terpene resin include aromatic modified terpene resin, hydrogenated terpene resin, and hydrogenated aromatic modified terpene resin. Examples of the modified terpene phenol resin include hydrogenated terpene phenol resin. Examples of the modified styrene resin include styrene acrylic resin, and styrene maleic resin. Examples of the modified xylene resin include phenol-modified xylene resin, alkylphenol-modified xylene resin, phenol-modified resol-type xylene resin, polyol modified xylene resin, and polyoxyethylene-added xylene resin.

Examples of other thermosetting resins include epoxy resins.

Examples of the epoxy resins include bisphenol A type epoxy resin, bisphenol F type epoxy resin, bisphenol S type epoxy resin, glycidyl amine type resin, alicyclic epoxy resin, aminopropane type epoxy resin, biphenyl type epoxy resin, naphthalene type epoxy resin, anthracene type epoxy resin, triazine type epoxy resin, dicyclopentadiene type epoxy resin, triphenylmethane type epoxy resin, fluorine type epoxy resin, phenolaralkyl type epoxy resin, and novolac type epoxy resin.

When the flux according to the present embodiment does not contain at least one resin component selected from the group consisting of the rosins and the thermosetting resins, the flux becomes more favorable as a water-soluble flux.

Since the above-mentioned water-soluble flux according to the present embodiment contains a keto acid having a melting point of 40° C. or less and a solvent having a boiling point of 240° C. or less in combination, the generation of voids can be further suppressed during reflow (at a reflow temperature of 180° C. to 300° C., for example). Although the reason such effects are exhibited is not clear, it is presumed to be as follows.

The melting point of an organic acid commonly used as an activator, such as dicarboxylic acid, is generally around 100° C. or more. In contrast, the melting point of the specific keto acid in the water-soluble flux according to the present embodiment is 40° C. or less. Since the water-soluble flux according to the present embodiment contains the specific keto acid, the fluidity of a solder paste during reflow is further enhanced. In addition, since the boiling point of the specific solvent in the water-soluble flux according to the present embodiment is 240° C. or less, the specific solvent is likely to volatilize during reflow, thereby generating bubbles (voids). It is presumed that these synergistic effects cause voids generated in the solder paste to coalesce together and become larger, thereby making it easier for the voids to be discharged from the solder paste.

In addition, when the boiling point of the specific keto acid is 250° C. or less, volatilization of the specific keto acid and the solvent occurs, thereby making it easier for the voids to be discharged from the solder paste.

### (Solder Paste)

A solder paste of the present embodiment contains a solder alloy powder and the above-mentioned flux.

The solder alloy powder may be composed of an Sn-only solder powder; or a powder of an Sn—Ag-based, Sn—Cu-based, Sn—Ag—Cu-based, Sn—Bi-based, or Sn—In-based solder alloy, or a powder of solder alloys in which Sb, Bi, In, Cu, Zn, As, Ag, Cd, Fe, Ni, Co, Au, Ge, P, or the like has been added to the above-mentioned alloys.

The solder alloy powder may be composed of a powder of an Sn—Pb-based solder alloy, or a powder of a solder alloy in which Sb, Bi, In, Cu, Zn, As, Ag, Cd, Fe, Ni, Co, Au, Ge, P, or the like has been added to the Sn—Pb-based solder alloy.

The solder alloy powder is preferably a Pb-free solder.

As the solder alloy powder, a solder alloy powder having a melting temperature of 150° C. to 250° C. may be used.

Amount of flux:

In the solder paste, the amount of the flux relative to the total mass of the solder paste is preferably 5% by mass to 30% by mass, and more preferably 5% by mass to 15% by mass.

Since the solder paste according to the present embodiment contains the flux including the keto acid having a melting point of 40° C. or less and the solvent having a boiling point of 240° C. or less, the generation of voids can be further suppressed.

It is presumed that the discharge of voids from a solder paste according to the present embodiment is facilitated by volatilization of the specific keto acid and the specific solvent in the solder paste during reflow, as mentioned above. Examples of the flux constitution which facilitates the discharge of voids from the solder paste include the following.

Namely, the flux contains the specific keto acid and the specific solvent, and the boiling point (Tk) of the specific keto acid and the boiling point (Ts) of the specific solvent preferably satisfy the following conditions.

The Tk is preferably 150° C. to 280° C., more preferably 200° C. to 270° C., even more preferably 220° C. to 260° C., and particularly preferably 230° C. to 250° C.

The Ts is preferably 150° C. to 240° C., more preferably 180° C. to 235° C., even more preferably 200° C. to 230° C., and particularly preferably 210° C. to 225° C.

The absolute value of the temperature difference ΔT between Tk and Ts is preferably 0° C. or more, more preferably 3° C. or more, and even more preferably 5° C. or more.

When the ΔT is the above-mentioned lower-limit or more, the generation of voids is likely to be further suppressed.

The ΔT is preferably 70° C. or less, more preferably 60° C. or less, and even more preferably 55° C. or less.

When the ΔT is the above-mentioned upper limit or less, the generation of voids is likely to be further suppressed.

In the flux, the amount of the specific keto acid relative to the total mass (100% by mass) of the flux may be 10% by mass to 25% by mass, 15% by mass to 25% by mass, or 15% by mass to 20% by mass.

In the flux, the amount of the specific solvent relative to the total mass (100% by mass) of the flux is preferably 10% by mass to 70% by mass, and more preferably 15% by mass to 60% by mass.

In addition, the Tk and the Ts preferably satisfy the relationship of Ts<Tk.

When the relationship is satisfied, the specific keto acid volatilizes together with the specific solvent that has already started to volatilize when the reflow temperature reaches the solder melting temperature. As a result, voids become likely to be further discharged from a solder paste.

In the case of Ts<Tk, the ΔT is preferably 5° C. to 50° C., more preferably 10° C. to 45° C., even more preferably 15° C. to 40° C., and particularly preferably 20° C. to 35° C.

When the ΔT is within the above-mentioned range, the generation of voids is likely to be further suppressed.

### EXAMPLES

Hereinafter, the present invention will be described with reference to examples, but the present invention is not limited to the following examples.

### <Preparation of Flux>

### Examples 1 to 9 and Comparative Examples 1 to 4

Each flux of examples and comparative examples was prepared using the constitutions shown in Tables 1 and 2.

Raw materials used are shown below.

The melting point values of the compounds used in examples were the values described in “Kagaku Binran, Basic Edition, Revised 5th Edition (The Chemical Society of Japan, Maruzen Publishing)”. The boiling point values of the compounds used in examples were the measured values of the temperature of target liquid at which the saturated vapor pressure of the target liquid was equal to one atmosphere (namely, 1013 hPa).

### Specific Keto Acid:

Levulinic acid (melting point: 37.2° C., boiling point: 245° C.)
Pyruvic acid (melting point: 13.6° C., boiling point: 165° C.)

### Other Keto Acid:

Acetonedicarboxylic acid (melting point: 138° C., boiling point: 408.4° C.)

### Other Organic Acid:

Glutaric acid
p-Toluenesulfonic acid

### Amine:

2-Ethylimidazole
Triethylenetetramine
N,N,N′,N′-tetrakis(2-hydroxypropyl)ethylenediamine
Diamine-terminated polyethylene glycol-polypropylene glycol copolymer (weight-average molecular weight: 600)

### Specific Solvent:

α-Terpineol (boiling point: 217° C.)
Ethylene glycol monophenyl ether (boiling point: 237° C.)
Hexylene glycol (boiling point: 197° C.)

### Other Solvent:

Diethylene glycol monohexyl ether (boiling point: 258° C.)
Diethylene glycol mono-2-ethyhexyl ether (boiling point: 272° C.)

### Surfactant:

Polyoxyethylene resorcinol (weight-average molecular weight: 1136)
Polyoxyethylene behenyl ether (average ethylene oxide addition molar number: 30 mol)

### <Preparation of Solder Paste>

A solder paste was prepared by mixing each flux of each example and the following solder alloy powder. The prepared solder paste was composed of 11% by mass of the flux and 89% by mass of the solder alloy powder.

The solder alloy powder in the solder paste was a powder composed of a solder alloy consisting of 3% by mass of Ag, 0.5% by mass of Cu, and a balance of Sn.

The solidus temperature of the solder alloy was 217° C., and the liquidus temperature thereof was 219° C.

The solder alloy powder had a size (particle size distribution) satisfying symbol 4 in the powder size classification (Table 2) in JIS Z 3284-1:2014.

### <Evaluation of Void Area Ratio>

### Verification Method:

A solder paste was printed on Ni/Au-plated electrodes using a metal mask (having the same opening size as that of an electrode and having a mask thickness of 80 μm). Then, a QFN (having a length of 4 mm on each side, the length of the bottom electrode on each side being 1.7 mm) was mounted on the electrodes on which the solder paste was printed. Then, reflow was performed to allow soldering to be proceed.

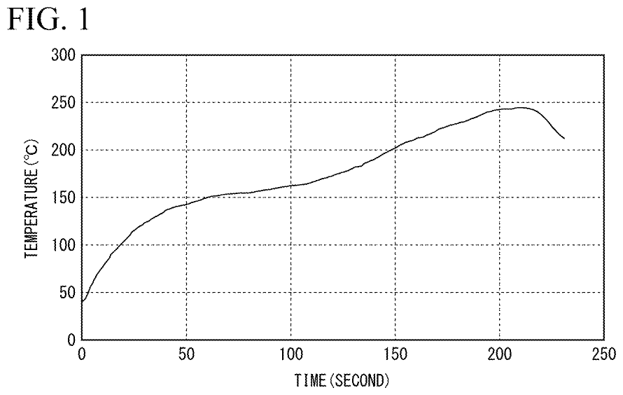

FIG. 1 is a drawing showing a reflow profile. In the reflow profile, the temperature was held at 150° C. to 180° C. for 70 seconds to conduct preheating, followed by holding the temperature at 220° C. or higher for 60 seconds, in which the peak temperature was 245° C.

The void area was measured by irradiating the soldered assembly with X-rays from a vertical direction of the substrate and analyzing the transmitted X-rays. An XD7600NT Diamond X-ray inspection system (manufactured by Nordson DAGE) was used to conduct the measurement. When the X-rays passed through at least one void in the measurement of the void area, the measurement was conducted as a case in which a void was present. Voids having a diameter of 0.1 μm or more were detected. Then, 10 the ratio of the total area of the voids relative to the total area of the bottom electrode was calculated and defined as the void area ratio (%).

TABLE 1

| | | | | Ex. | Ex. | Ex. | Ex. | Ex. | Ex. | Ex. | Ex. | Ex. |
|---|---|---|---|---|---|---|---|---|---|---|---|---|
| | | | | 1 | 2 | 3 | 4 | 5 | 6 | 7 | 8 | 9 |
| Activator | Organic | Specific | Levulinic acid | 20 | 20 | 20 | | 20 | 25 | 20 | 15 | 10 |
| | acid | keto acid | (melting point: 37.2° C., | | | | | | | | | |
| | | | boiling point: 245° C.) | | | | | | | | | |
| | | | Pyruvic acid | | | | 20 | | | | | |
| | | | (melting point: 13.6° C., | | | | | | | | | |
| | | | boiling point: 165° C.) | | | | | | | | | |
| | | Other | Acetonedicarboxylic acid | | | | | | | | | |
| | | keto acid | (melting point: 138° C., | | | | | | | | | |
| | | | boiling point: 408.4° C.) | | | | | | | | | |
| | | Other | Glutaric acid | 1 | 1 | 1 | 1 | 1 | 1 | 1 | 1 | 1 |
| | | organic | p-Toluenesulfonic acid | 2 | 2 | 2 | 2 | 2 | 2 | 2 | 2 | 2 |
| | | acid | | | | | | | | | | |

| | | | | | | | | | | | |
|---|---|---|---|---|---|---|---|---|---|---|---|
| | Amine | 2-Ethylimidazole | 2 | 2 | 2 | 2 | 2 | 2 | 2 | 2 | 2 |
| | | Triethylenetetramine | 0.2 | 0.2 | 0.2 | 0.2 | 0.2 | 0.2 | 0.2 | 0.2 | 0.2 |
| | | N,N,N′,N′-tetrakis(2-hydroxy- | 21.8 | 21.8 | 21.8 | 21.8 | 19.5 | 19.5 | 22 | 24.5 | 27 |
| | | propyl)ethylenediamine | | | | | | | | | |
| | | Diamine-terminated | | | | | | 12 | 12 | 12 | 12 |
| | | polyethylene glycol- | | | | | | | | | |
| | | polypropylene | | | | | | | | | |
| | | glycol copolymer | | | | | | | | | |
| Solvent | Specific | α-Terpineol | 46 | | | 46 | 33.3 | 16.3 | 18.8 | 21.3 | 38.8 |
| | solvent | (boiling point: 217° C.) | | | | | | | | | |
| | | Ethylene glycol | | 46 | | | | | | | |
| | | monophenyl ether | | | | | | | | | |
| | | (boiling point: 237° C.) | | | | | | | | | |
| | | Hexylene glycol | | | 46 | | | | | | |
| | | (boiling point: 197° C.) | | | | | | | | | |
| | Other solvent | Diethylene glycol | | | | | | | | | |
| | | monohexyl ether | | | | | | | | | |
| | | (boiling point: 258° C.) | | | | | | | | | |
| | | Diethylene glycol | | | | | | | | | |
| | | mono-2-ethyhexyl ether | | | | | | | | | |
| | | (boiling point: 272° C.) | | | | | | | | | |

| Surfactant | Polyoxyethylene resorcinol | | | | | 15 | 15 | 15 | 15 | |
|---|---|---|---|---|---|---|---|---|---|---|
| | Polyoxyethylene behenyl ether | 7 | 7 | 7 | 7 | 7 | 7 | 7 | 7 | 7 |
| Total (% by mass) | | 100 | 100 | 100 | 100 | 100 | 100 | 100 | 100 | 100 |
| Specific keto acid/total amount of organic acid (% by mass) | | 87.0 | 87.0 | 87.0 | 87.0 | 87.0 | 89.3 | 87.0 | 83.3 | 76.9 |
| Evaluation results | Specific solvent/specific | 2.30 | 2.30 | 2.30 | 2.30 | 1.67 | 0.65 | 0.94 | 1.42 | 3.88 |
| | keto acid (mass ratio) | | | | | | | | | |
| | Evaluation of void | 10.7 | 15.2 | 14.1 | 14.6 | 17.7 | 11 | 10.8 | 13 | 18.8 |
| | area ratio (%) | | | | | | | | | |

(Ex.: Example)

TABLE 2

| | | | | C. Ex. | C. Ex. | C. Ex. | C. Ex. |
|---|---|---|---|---|---|---|---|
| | | | | 1 | 2 | 3 | 4 |
| Activator | Organic | Specific | Levulinic acid | 20 | 20 | | |
| | acid | keto acid | (melting point: 37.2° C., | | | | |
| | | | boiling point: 245° C.) | | | | |
| | | | Pyruvic acid | | | | |
| | | | (melting point: 13.6° C., | | | | |
| | | | boiling point: 165° C.) | | | | |
| | | Other | Acetonedicarboxylic acid | | | 20 | |
| | | keto acid | (melting point: 138° C., | | | | |
| | | | boiling point: 408.4° C.) | | | | |
| | | Other | Glutaric acid | 1 | 1 | 1 | 1 |
| | | organic | p-Toluenesulfonic acid | 2 | 2 | 2 | 2 |
| | | acid | | | | | |

| | | | | | | |
|---|---|---|---|---|---|---|
| | Amine | 2-Ethylimidazole | 2 | 2 | 2 | 2 |
| | | Triethylenetetramine | 0.2 | 0.2 | 0.2 | 0.2 |
| | | N,N,N′,N′-tetrakis(2-hydroxy- | 21.8 | 21.8 | 21.8 | 30 |
| | | propyl)ethylenediamine | | | | |
| | | Diamine-terminated | | | | 12 |
| | | polyethylene glycol- | | | | |
| | | polypropylene | | | | |
| | | glycol copolymer | | | | |
| Solvent | Specific | α-Terpineol | | | 46 | 30.8 |
| | solvent | (boiling point: 217° C.) | | | | |
| | | Ethylene glycol | | | | |
| | | monophenyl ether | | | | |
| | | (boiling point: 237° C.) | | | | |
| | | Hexylene glycol | | | | |
| | | (boiling point: 197° C.) | | | | |
| | Other solvent | Diethylene glycol | 46 | | | |
| | | monohexyl ether | | | | |
| | | (boiling point: 258° C.) | | | | |
| | | Diethylene glycol | | 46 | | |
| | | mono-2-ethyhexyl ether | | | | |
| | | (boiling point: 272° C.) | | | | |

| Surfactant | Polyoxyethylene resorcinol | | | | 15 |
|---|---|---|---|---|---|
| | Polyoxyethylene behenyl ether | 7 | 7 | 7 | 7 |
| Total (% by mass) | | 100 | 100 | 100 | 100 |
| Specific keto acid/total amount of organic acid (% by mass) | | 87.0 | 87.0 | 0 | 0 |
| Evaluation results | Specific solvent/specific | 0.00 | 0.00 | — | — |
| | keto acid (mass ratio) | | | | |
| | Evaluation of void | 24 | 29.1 | 24.4 | 25.7 |
| | area ratio (%) | | | | |

(C. Ex.: Comparative Example)

When the fluxes of Comparative Examples 1 and 2 were used, in which the specific solvent was absent, the generation of voids could not be sufficiently suppressed.

When the fluxes of Comparative Examples 3 and 4 were used, in which the specific keto acid was absent, the generation of voids could not be sufficiently suppressed.

When the fluxes of Examples 1 to 9 containing the specific keto acid and the specific solvent were used, the generation of voids could be further suppressed in comparison with the cases in which the fluxes of the comparative examples were used.

The flux of Example 1, containing levulinic acid (having a boiling point of 245° C.) and α-terpineol (having a boiling point of 217° C.), could further suppress the generation of voids in comparison with the flux of Example 4 containing pyruvic acid (having a boiling point of 165° C.) and α-terpineol (having a boiling point of 217° C.).

In Example 1, when the reflow temperature reached the solder melting temperature, levulinic acid (specific keto acid) volatilized together with α-terpineol that had already started to volatilize. In contrast, before the reflow temperature reached the solder melting temperature, the volatilization of pyruvic acid (specific keto acid) had already proceeded, followed by volatilizing α-terpineol, in Example 4. It was assumed that this difference allowed the flux of Example 1 to promote the discharge of voids from a solder paste in comparison with the flux of Example 4.

### INDUSTRIAL APPLICABILITY

According to the present invention, a flux and a solder paste which can further suppress the generation of voids can be provided. This flux and solder paste are suitable to solder a QFN or the like, in which there are no leads around a package.

1. A water-soluble flux comprising: a keto acid having a melting point of 40° C. or less; and a solvent having a boiling point of 240° C. or less.

2. The water-soluble flux according to claim 1, wherein a boiling point of the keto acid is 250° C. or less.

3. The water-soluble flux according to claim 1, wherein an amount of the keto acid relative to a total mass of the water-soluble flux is 10% by mass to 25% by mass.

4. The water-soluble flux according to claim 1, wherein the keto acid comprises an organic acid having one carboxy group in a molecule thereof.

5. The water-soluble flux according to claim 4, wherein the keto acid comprises a levulinic acid.

6. The water-soluble flux according to claim 1, wherein
a ratio of the solvent to the keto acid, which is a mass ratio indicated by solvent/keto acid, is 0.60 to 4.0.

7. The water-soluble flux according to claim 1, further comprising a nonionic surfactant and an amine.

8. The water-soluble flux according to claim 1, wherein at least one resin component selected from the group consisting of rosins and thermosetting resins is absent.

9. A solder paste comprising: a solder alloy powder; and a water-soluble flux of claim 1.
